(19) United States
(12) Patent Application Publication
(10) Pub. No.: US 2013/0092057 A1
(43) Pub. Date: Apr. 18, 2013

(54) Treatment Method and Treatment Apparatus for Converting Chlorine-Containing Waste into Raw Material for Cement

(71) Applicants: Masayoshi Konishi, Chiyoda-ku (JP); Taisuke Araki, Chiyoda-ku (JP); Takako Morikawa, Chiyoda-ku (JP)

(72) Inventors: Masayoshi Konishi, Chiyoda-ku (JP); Taisuke Araki, Chiyoda-ku (JP); Takako Morikawa, Chiyoda-ku (JP)

(73) Assignee: SUMITOMO OSAKA CEMENT CO., LTD., Chiyoda-ku-Tokyo (JP)

(21) Appl. No.: 13/637,500

(22) PCT Filed: Mar. 28, 2011
(86) PCT No.: PCT/JP2011/057551

§ 371 Date: Dec. 10, 2012

(30) Foreign Application Priority Data
Mar. 31, 2010 (JP) 2010-081460

(51) Int. Cl. C04B 18/08

(52) U.S. Cl. CPC C04B 18/08
USPC 106/819; 422/187

(57) ABSTRACT

In the treatment method for converting chlorine-containing waste into raw material for cement, fly ash and desalinated dust are treated, harmful substances such as selenium or heavy metals are removed from the chlorine-containing waste which is the fly ash or desalinated dust by a polymer flocculant or a chelating agent, or by a reducing agent, a polymer flocculant, and electrolytic treatment, and solid components that are generated during the treatment is used as the raw material for cement.

### TECHNICAL FIELD

The present invention relates to a treatment method and treatment apparatus for converting chlorine-containing waste into a raw material for cement which treat chlorine-containing waste containing heavy metals such as fly ash discharged from a refuse incinerator or the like, and desalinated dust generated in alkali bypass equipment and chlorine bypass equipment in manufacturing of cement so as to be used as a raw material for cement.

### BACKGROUND ART

In recent years, in cement manufacturing equipment, volatile components such as chlorine contained in industrial waste have increased in kilns according to an increase of throughput of industrial waste, which may adversely affect quality of cement or an operation of a cement kiln system. Therefore, as a countermeasure against the above, a chlorine bypass device which removes chlorine from the cement manufacturing equipment is installed.

In the chlorine bypass device, in order to remove volatile components such as chlorine that is agglomerated by repeating volatilization and concentration between a cement kiln and a preheater, chlorine bypass dust in which volatile components mainly containing chlorine compound are solidified is generated by extracting exhaust gas from a kiln end of the cement kiln and by cooling it, and the chlorine is removed from the inner portion of the cement kiln by discharging the chlorine bypass dust to the outside of the system.

Since the chlorine bypass dust that is generated in the chlorine bypass device contains a large quantity of chlorine compound, heavy metals, and the like, in order to reuse the raw material for cement, the chlorine compound, heavy metals, and the like are required to be removed.

In addition, fly ash that is discharged from a refuse incinerator is particularly controlled. In treatments of the waste such as a fusion method, a cement solidification method, a chemical agent treatment method, a solvent extraction method, in general, conducting a pretreatment by any one of the methods is obligated, and thereafter, the fly ash is subjected to a landfill disposal.

Since the fly ash contains a large quantity of chlorine compound, heavy metals, and the like, in order to reuse the raw material for cement, the chlorine compound, heavy metals, and the like are required to be removed.

In this way, the fly ash is pretreated and is subjected to landfill disposal. However, in recent years, securing of landfill disposal sites, soil pollution of the periphery of the landfill disposal sites due to elution of harmful components from the fly ash, and the like have become problems.

In addition, since alkali bypass dust and chlorine bypass dust contain a large quantity of chlorine compound, there is a concern that quality decrease of the cement may occur when the dust is mixed into the cement of the product. In recent years, recycling of waste at the cement kiln has progressed, a chlorine amount from the waste may be also increased, and a quantity of generation of the alkali bypass dust and the chlorine bypass dust is also increased according to this. In addition, in the case of disposal, expenses are incurred due to the disposal, and the securing of the landfill disposal sites has become an important problem similar to the waste incineration fly ash.

In Japanese patent No. 4210456, a treatment method for converting chlorine-containing waste into a raw material for cement is disclosed in which water of an amount which fluidizes waste is added to waste containing chlorine and suspended in a stirred vessel, chlorine in the waste is eluted, the eluted chlorine is filtered by a belt filter or a filter press, the obtained desalination cake is used as a raw material for cement, chemical agents are added or gas containing carbon dioxide gas is blown in order to adjust pH of a filtrate in which chlorine and heavy metals in the waste are eluted by water washing, heavy metals and harmful components are precipitated by using chelating agent addition and/or chelating resin adsorption and/or activated carbon adsorption together, and the precipitates are removed by filtering.

However, in the method of Japanese patent No. 4210456, the raw material for cement is not effectively and sufficiently generated from the chlorine-containing waste, and the method is not a comprehensive treatment method capable of concurrently treating the fly ash and desalinated dust. In addition, since the precipitation treatment of the heavy metals is not conducted so as to be repeated, the method is not a satisfactory method in which the contained heavy metals are sufficiently removed.

In addition, in Japanese Unexamined Patent Application Publication No. 2009-172552 A, a method of treating waste containing water soluble chlorine is disclosed which includes a process of water washing and solid-liquid separation which separates a slurry S1 consisting of waste D containing water-soluble chlorine and fresh water W into solid components C1 and filtrate F1 by solid-liquid separation, a process of removing selenium which separates a slurry S2 into solid components C2 and supernatant F2 containing selenium and iron powder through settling separation by adding a pH adjusting agent P1 to the filtrate F1 and adjusting pH to 4 or more and 7 or less, further by adding iron powder and subjecting to reduction and precipitation of selenium in the obtained slurry S2 through the iron powder, and a process of neutralization which precipitates the heavy metals by adjusting pH of the supernatant F2 to 7 or more and 10.5 or less and which separates the supernatant F2 into solid components C3 containing heavy metals and supernatant F3 by the settling separation.

The method of Japanese Unexamined Patent Application Publication No. 2009-172552 is effective as the method of removing the selenium. However, the method does not disclose a comprehensive treatment method capable of concurrently treating the fly ash and desalinated dust.

### CITATION LIST

### Patent Literature

[PTL 1] Japanese patent No. 4210456

[PTL 2] Japanese Unexamined Patent Application Publication No. 2009-172552 A

### SUMMARY OF INVENTION

### Technical Problem

An object of the present invention is to solve the above-described problems of the related art and to provide a comprehensive treatment method for converting chlorine-containing waste into a raw material for cement capable of effectively treating a large quantity of harmful components such as heavy metals included in chlorine-containing waste, which is fly ash or desalinated dust, in a concurrent manner, capable of discharging a waste liquid which is environmentally safe with excellent removal of the contained heavy metals, and capable of effectively recycling waste incineration fly ash, alkali bypass dust, chlorine bypass dust, and a mixture thereof which are the chlorine-containing waste as the raw material for cement.

In addition, another object of the present invention is to provide a treatment apparatus capable of effectively conducting the chlorine containing treatment method.

### Solution to Problem

In order to solve the above-described problems, as follows, the present invention is to provide a treatment method and treatment apparatus for converting chlorine-containing waste into a raw material for cement capable of comprehensively and effectively treating fly ash and desalinated dust.

A treatment method for converting chlorine-containing waste into a raw material for cement of the present invention includes,

fluidizing the waste (D) by adding water to chlorine-containing fly-ash waste (D) and conducting solid-liquid separation by filtering (2, 22) slurry (S1) in which the chlorine is dissolved (1), using the obtained solid cake C2 and C22 as the raw material for cement, precipitating (11) heavy metals by adjusting pH of filtrate F2 and F21 to 9 to 10 and adding a reducing agent, adding a polymer flocculant (12) to the slurry S11 containing the heavy metals precipitates, settling flock by agglomerating the heavy metals, conducting solid-liquid separation (15) by filtering the flock, using the obtained solid cake C15 as the raw material for cement, circulating filtrate F15 in the precipitation (11) treatment of the heavy metals, adding (13) a chelating agent to supernatant F12 after separating the settled flock, conducting solid-liquid separation by filtering (14) slurry S13 in which chelates of the heavy metals are formed, circulating the obtained solid components M14 in the polymer flocculant treatment (12), and discharging filtrate F14,

fluidizing the waste by adding water to the chlorine-containing desalinated dust waste (D), conducting solid-liquid separation by filtering (22) slurry S21 in which the chlorine is dissolved (21), using the obtained solid cake C22 as the raw material for cement, precipitating and settling (24) selenium by adjusting pH of filtrate F22 to 5 to 6 and adding (23) iron powder or ferrous chloride, conducting solid-liquid separation (27) by filtering the precipitates, using the obtained solid cake C27 as the raw material for cement, precipitating (25) the heavy metals by adjusting pH of supernatant F24 after separating the settled selenium to 9 to 10 and adding a reducing agent, adding a polymer flocculant (26) to slurry S25 containing the heavy metal precipitates, settling flock by agglomerating the heavy metals, conducting solid-liquid separation (27) by filtering the flock, using the obtained solid cake C27 as the raw material for cement, circulating filtrate F27 in the precipitating (25) treatment of the heavy metals, precipitating metallic oxide by applying direct current to the supernatant F26 after separating the flock and electrolyzing (28), conducting solid-liquid separation by filtering (29) slurry S28 containing the metallic oxide, circulating solid components M29 in the polymer flocculant treatment, and discharging filtrate F29, and

conducting the treatment similar to the chlorine containing desalinated dust treatment to the filtrate F2 along with the supernatant F24 after separating the selenium from the filtrate F2.

Preferably, in the treatment method for converting chlorine-containing waste into a raw material for cement of the present invention, the slurry S1 in which the fly ash is dissolved in water and the slurry S21 in which the desalinated dust is dissolved in water are not simultaneously subjected to the solid-liquid separation (22) treatment.

More preferably, in the treatment method for converting chlorine-containing waste into a raw material for cement of the present invention, the chlorine-containing fly-ash waste is further subjected to dioxin pretreatment before dissolving (1) the chlorine by adding water to the chlorine-containing fly-ash waste (D) and fluidizing the waste.

More preferably, in the treatment method for converting chlorine-containing waste into a raw material for cement of the present invention, the metallic oxide that is precipitated by electrolyzing (28) is an oxide of thallium, and further includes a treatment that recovers the thallium by conducting decantation of the slurry containing the oxide of thallium.

Still more preferably, in the treatment method for converting chlorine-containing waste into a raw material for cement of the present invention, the liquid is further subjected to activated carbon adsorption (30) treatment before the discharging.

A treatment apparatus for converting chlorine-containing waste into a raw material for cement of the present invention includes,

a dissolving vessel (1) in which water is added to chlorine-containing fly-ash waste (D), the waste is fluidized, and the chlorine is dissolved, a filtering device (2) in which a solid cake C2 that is obtained by filtering slurry S1 from the dissolving vessel (1) and conducting solid-liquid separation is used as the raw material for cement, a reaction vessel (11) in which pH of filtrate F2 from the filtering device (2) is adjusted to 9 to 10, a reducing agent is added, and heavy metals are precipitated, a flocculate vessel (12) in which a polymer flocculant is added to slurry S11 containing the heavy metal precipitates from the reaction vessel (11), the heavy metals are agglomerated and flock is settled, a filtering device (15) in which the flock is filtered, a solid cake C15 that is obtained by conducting solid-liquid separation is used as the raw material for cement, and filtrate F15 is circulated in the reaction vessel (11), a chelating vessel (13) in which a chelate of the heavy metals is formed by adding a chelating agent to supernatant F12 from the flocculate vessel (12), and a filtering device (14) in which slurry S13 from the chelating vessel (13) is filtered, solid-liquid separation is conducted, solid components M14 are circulated in the flocculate vessel (12), and filtrate 14 is discharged,

a dissolving vessel (21) in which water is added to chlorine-containing desalinated dust waste (D), the waste is fluidized, and the chlorine is dissolved, a filtering device (22) in which a solid cake C22 that is obtained by filtering slurry S21 from the dissolving vessel (21) and conducting solid-liquid separation is used as the raw material for cement, a reaction vessel (23) in which pH of filtrate F22 from the filtering device (22) is adjusted to 5 to 6, iron powder or ferrous chloride is added (23), and selenium is precipitated, a settling vessel (24) in which selenium is settled from slurry 23 containing the selenium that is precipitated from the reaction vessel (23), a filtering device (27) in which a solid cake C27 that is obtained by filtering the precipitates and conducting the solid-liquid separation is used as the raw material for cement, a reaction vessel (25) in which pH of supernatant F24 from the settling vessel (24) is adjusted to 9 to 10, a reducing agent is added, and a heavy metals are precipitated, a flocculate vessel (26) in which a polymer flocculant is added to slurry S25 containing the heavy metal precipitates from the reaction vessel (25), the heavy metals are agglomerated and flock is settled, a filtering device (27) in which a solid cake C27 that is obtained by filtering the flock and conducting the solid-liquid separation is used as the raw material for cement and filtrate F27 is circulated in the reaction vessel (25), an electrolysis vessel (28) in which electrolysis is conducted by applying direct current to supernatant F26 from the flocculate vessel (26) and metallic oxide is precipitated, a filtering device (29) in which slurry S28 containing the metallic oxide from the electrolysis vessel (28) is filtered, solid-liquid separation is conducted, solid components M29 are circulated in the flocculate vessel (26), and filtrate F29 is discharged, and

the filtrate F2 is introduced to the filtering device 22 and is subjected to a treatment similar to the chlorine containing desalinated dust treatment.

Preferably, in the treatment apparatus for converting chlorine-containing waste into a raw material for cement of the present invention, the slurry S1 in which the fly ash is dissolved in water and the slurry S21 in which the desalinated dust is dissolved in water are not simultaneously introduced to the filtering device (22).

More preferably, in the treatment apparatus for converting chlorine-containing waste into a raw material for cement of the present invention, further comprising a dioxin treatment device in which the chlorine-containing fly-ash waste is subjected to dioxin pretreatment before being introduced to the dissolving vessel (1).

More preferably, in the treatment apparatus for converting chlorine-containing waste into a raw material for cement of the present invention, the metallic oxide that is precipitated by the electrolysis vessel (28) is an oxide of thallium, and further comprises the recovering means in which the thallium is recovered by conducting decantation of the slurry containing the oxide of thallium.

Still more preferably, the treatment apparatus for converting chlorine-containing waste into a raw material for cement of the present invention further includes, an activated carbon adsorption device (30) that conducts an activated carbon treatment before discharging the filtrate F14 and filtrate F29 from the filtering devices (14 and 29).

### Advantageous Effects of Invention

According to the treatment method and treatment apparatus for converting chlorine-containing waste into a raw material for cement of the present invention, the fly ash or the desalinated dust can be comprehensively treated, and the fly ash or the desalinated dust can be concurrently treated. In addition, in the present invention, since the removal of the heavy metals is sequentially conducted by various means, harmful components such as selenium and heavy metals that are contained in the fly ash, the desalinated dust, or the like can be effectively removed, and the contained heavy metals can be completely removed. In addition, solid materials that are generated in various treatment steps can be effectively recycled as the raw material for cement, and the solid components that are used in the raw material for cement can be produced in multiple steps.

### BRIEF DESCRIPTION OF DRAWINGS

FIG. 1 is a diagram of an example that schematically shows a treatment apparatus for conducting a treatment method for converting chlorine-containing waste into a raw material for cement of the present invention.

### DESCRIPTION OF EMBODIMENTS

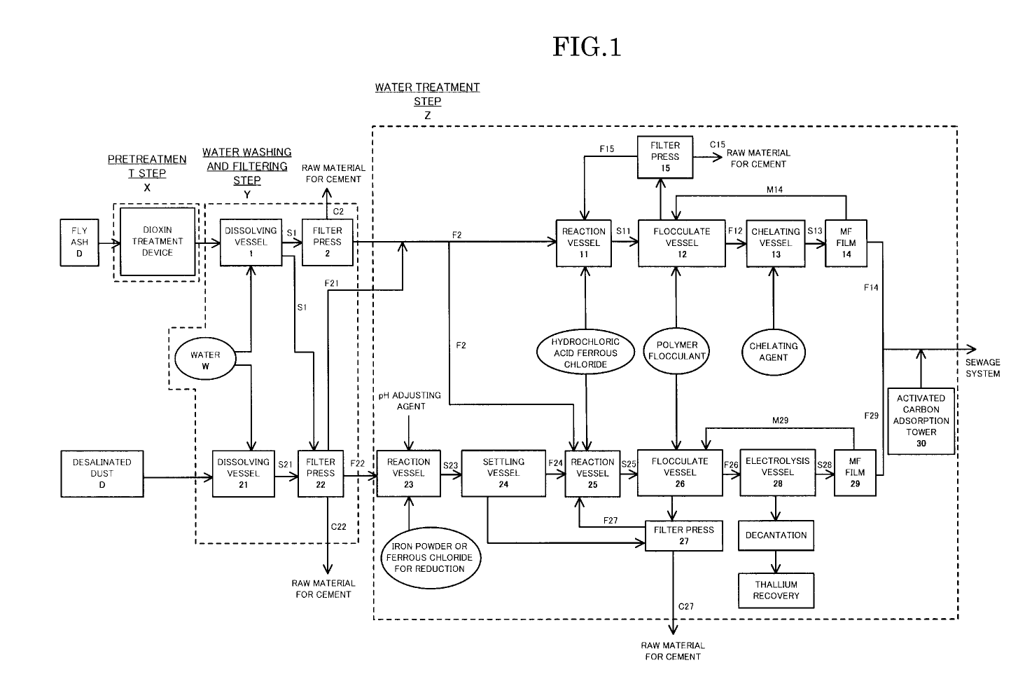

The present invention will be described in detail below with reference to FIG. 1.

A treatment method for converting chlorine-containing waste into a raw material for cement of the present invention is a treatment method that includes the following steps, and specifically, is a treatment method for converting chlorine-containing waste into the raw material for cement that includes fluidizing the waste by adding water to chlorine-containing fly-ash waste (D) and conducting solid-liquid separation by filtering (2, 22) slurry (S1) in which the chlorine is dissolved (1), using the obtained solid cake C2 and C22 as the raw material for cement, precipitating (11) heavy metals by adjusting pH of filtrate F2 and F21 to 9 to 10 and adding a reducing agent, adding a polymer flocculant (12) to the slurry S11 containing heavy metal precipitates, settling flock by agglomerating the heavy metals, conducting solid-liquid separation (15) by filtering the flock, using the obtained solid cake C15 as the raw material for cement, circulating filtrate F15 in the precipitation (11) treatment of the heavy metals, adding (13) a chelating agent to supernatant F12 after separating the settled flock, conducting solid-liquid separation by filtering (14) slurry S13 in which a chelate of the heavy metals is formed, circulating the obtained solid components M14 in the polymer flocculant treatment (12), and discharging filtrate F14,

fluidizing the waste by adding water to the chlorine-containing desalinated dust waste (D), conducting solid-liquid separation by filtering (22) slurry S21 in which the chlorine is dissolved (21), using the obtained solid cake C22 as the raw material for cement, precipitating and settling (24) selenium by adjusting pH of filtrate F22 to 5 to 6 and adding (23) iron powder or ferrous chloride, conducting solid and liquid separation (27) by filtering the precipitates, using the obtained solid cake C27 as the raw material for cement, precipitating (25) the heavy metals by adjusting pH of supernatant F24 after separating the settled selenium to 9 to 10 and adding a reducing agent, adding a polymer flocculant (26) to slurry S25 containing the heavy metal precipitates, settling flock by agglomerating the heavy metals, conducting solid-liquid separation (27) by filtering the flock, using the obtained solid cake C27 as the raw material for cement, circulating filtrate F27 in the precipitation (25) treatment of the heavy metals, precipitating metallic oxide by applying direct current to the supernatant F26 after separating the flock and electrolyzing (28), conducting solid-liquid separation by filtering (29) slurry S28 containing the metallic oxide, circulating solid components M29 in the polymer flocculant treatment, and discharging filtrate F29, and

conducting the treatment similar to the chlorine containing desalinated dust treatment to the filtrate F2 along with the supernatant F24 after separating the selenium.

A treatment apparatus for chlorine-containing waste of the present invention is a treatment apparatus that includes the following means, and specifically, is a treatment apparatus for converting chlorine-containing waste into the raw material for cement that includes, a dissolving vessel (1) in which water is added to chlorine-containing fly-ash waste (D), the waste is fluidized, and the chlorine is dissolved, a filtering device (2) in which a solid cake C2 that is obtained by filtering slurry S1 from the dissolving vessel (1) and conducting solid-liquid separation is used as the raw material for cement, a reaction vessel (11) in which pH of filtrate F2 from the filtering device (2) is adjusted to 9 to 10, a reducing agent is added, and heavy metals are precipitated, a flocculate vessel (12) in which a polymer flocculant is added to slurry S11 containing the heavy metal precipitates from the reaction vessel (11), the heavy metals are agglomerated and flock is settled, a filtering device (15) in which the flock is filtered, a solid cake C15 that is obtained by conducting solid-liquid separation is used as the raw material for cement, and filtrate F15 is circulated in the reaction vessel (11), a chelating vessel (13) in which a chelate of the heavy metals is formed by adding a chelating agent to supernatant F12 from the flocculate vessel (12), and a filtering device (14) in which slurry S13 from the chelating vessel (13) is filtered, solid-liquid separation is conducted, solid components M14 are circulated in the flocculate vessel (12), and filtrate 14 is discharged,

a dissolving vessel (21) in which water is added to chlorine-containing desalinated dust waste (D), the waste is fluidized, and the chlorine is dissolved, a filtering device (22) in which a solid cake C22 that is obtained by filtering slurry S21 from the dissolving vessel (21) and conducting solid-liquid separation is used as the raw material for cement, a reaction vessel (23) in which pH of filtrate F22 from the filtering device (22) is adjusted to 5 to 6, iron powder or ferrous chloride is added (23), and selenium is precipitated, a settling vessel (24) in which selenium is settled from slurry 23 containing the selenium that is precipitated from the reaction vessel (23), a filtering device (27) in which a solid cake C27 that is obtained by filtering the precipitates and conducting the solid-liquid separation is used as the raw material for cement, a reaction vessel (25) in which pH of supernatant F24 from the settling vessel (24) is adjusted to 9 to 10, a reducing agent is added, and heavy metals are precipitated, a flocculate vessel (26) in which a polymer flocculant is added to slurry S25 containing the heavy metal precipitates from the reaction vessel (25), the heavy metals are agglomerated and flock is settled, a filtering device (27) in which a solid cake C27 that is obtained by filtering the flock and conducting the solid-liquid separation is used as the raw material for cement and filtrate F27 is circulated in the reaction vessel (25), an electrolysis vessel (28) in which electrolysis is conducted by applying direct current to supernatant F26 from the flocculate vessel (26) and metallic oxide is precipitated, a filtering device (29) in which slurry S28 containing the metallic oxide from the electrolysis vessel (28) is filtered, solid-liquid separation is conducted, solid components M29 are circulated in the flocculate vessel (26), and filtrate F29 is discharged, and

the filtrate F2 is introduced to the filtering device 22 and is subjected to a treatment similar to the chlorine containing desalinated dust treatment.

### A. Fly Ash

### [Pretreatment Step X]

When fly ash dust is treated, a pretreatment is conducted if necessary, and dioxin treatment is conducted being introduced to the dissolving vessel (1). The dioxin treatment can use a known dioxin treatment device, dioxins that are contained in the fly ash are treated so as to be removed in the device, and concentration of the dioxins that are contained in the fly ash can be very rapidly decreased to less than or equal to a criterion.

Subsequently to the pretreatment that is provided as necessary, a water washing and filtering step is conducted.

### [Water Washing and Filtering Step Y]

### (Dissolving Step)

First, the fly ash which is chlorine-containing waste D is input to the dissolving vessel (1), water W of an amount which fluidizes the fly ash is added in an amount of 2 to 10 times by mass that of the fly ash D and stirred, the fly ash becomes a slurry, and soluble components such as the contained chlorine compound are eluted and repulped.

As the water W, industrial water, second drainage that is discharged from manufacturing operations or the like, or waterworks, or the like is used.

Here, the reason why the added amount of the water is as above is because the elution of the soluble components in the chlorine-containing waste D is not sufficiently conducted and the soluble components, that remain in each of desalinated cake solid components (C2, C22) obtained by being filtered through filters (2, 22) of the subsequent state, are increased if the mass of the added amount of the water is 2 times or less than that of the chlorine-containing waste D. In addition, viscosity of the obtained slurry is increased, and pumping toward the subsequent step is difficult.

Moreover, if the mass of the added amount of the water is 10 times or more than that of the chlorine-containing waste D, elution of other components such as heavy metals is increased, and therefore, in the subsequent step, the amount of chemical agents used for removing the components increases.

In the repulping, in order to increase dissolution rates of the soluble components, a temperature in the inner portion of the dissolving vessel (1) may be increased to 40° C. or more. In addition, chlorine components can be sufficiently dissolved within 10 hours of stirring. However, stirring for a long time generates double salt of calcium, alkali components, and chlorine that are contained in the dust, precipitates are generated, and therefore, there is a concern that sufficient desalination may not be conducted, which is unfavorable.

### (Filtering Step)

The slurry S1 generated by the repulping is input to the filtering device (2), is compressed, and is subjected to the solid-liquid separation. Therefore, the solid components C2 of the fly ash dewatered cake and the filtrate F2 are separated.

In addition, the slurry 1 is introduced to the filtering device (22) that is used in the following desalinated dust treatment step and is compressed. In addition, the slurry is subjected to the solid-liquid separation, and the solid components C22 of the fly ash dewatered cake and filtrate F21 may be separated. In this case, the filtering treatment is conducted so that the slurry S21 from the dissolving vessel (21) of the desalinated dust treatment and the slurry S1 are not mixed with each other. In the apparatus of the present invention, when the filtering device is single, if the slurry S1 in the fly ash treatment and the slurry S22 in the desalinated dust are not mixed with each other, a common filtering device can be used. In this case, the filtrate F21 that is discharged from the filtering device (22) is subjected to the following treatment similar to the filtrate F2.

As the filtering device, a filter press or a belt filter is used.

In addition, if necessary, water W is introduced into the filtering device (2, 22), and moisture containing the residual soluble components in the solid components (C2, C22) may be cleaned away by the water W. In the cleaning with the water W, the water W is fed to the solid components (C2, C22) by pressure from one direction in a state where the filtering device (2, 22) is pressurized. Therefore, the cleaning is effectively conducted with a small quantity of water.

It is preferable that an amount of the water W used for conducting the cleaning be 0.5 to 2.0 times by mass that of the amount of the waste that is supplied in the desalination and cleaning.

The solid components (C2, C22) of the obtained fly ash dewatered cake are effectively used as the raw material for cement. For example, when the solid components (C2, C22) are directly fed to cement manufacturing equipment, the solid components are mixed with other raw material for cement, and after the resulting mixture is dried and ground, it is used so as to be recirculated as a powder raw material for cement in a cement burning step and burnt as cement clinker.

### [Water Treatment Step Z]

### (Heavy Metal Removal Step)

In the filtrate F2 that is discharged from the filtering device (2), chlorine is eluted in the fly ash D, and heavy metals and the like are also included. Therefore, a pH adjusting agent is added to the filtrate F2, a polymer flocculant is also added, precipitates that include heavy metals contained in the filtrate F2 are generated, and the precipitates are filtered and separated.

In addition, the filtrate F2 is introduced to the reaction vessel (25) in the desalinated dust treatment as below, and the following treatments may be conducted via a treatment step similar to the desalinated dust treatment as below.

The filtrate F2 of the filtering device (2) is input to the reaction vessel (11), and for a purpose of reduction, coprecipitation, and concentration of a metal and/or an inorganic material, for example, ferrous sulfate (FeSO₄), ferrous chloride (FeCl₂), and the like are added to the filtrate F2 and reacted, and the slurry S11 is generated.

For example, in the heavy metals, pH of the filtrate F2 is approximately 9 to 10.5 in the reaction vessel (11), precipitates of hydroxide of the heavy metals are generated, and therefore, the heavy metals can be removed to a significant extent.

In addition, as the pH adjusting agent, an acid may be used, and most preferably, HCl may be used.

Subsequently, in the flocculate vessel (12), the polymer flocculant is added to the slurry S11 from the reaction vessel (11), and therefore, heavy metals in the slurry S11, microparticulated heavy metals, or heavy metal hydroxides are agglomerated and settled.

The precipitates in the flocculate vessel (12) are fed to the filtering device (for example, filter press) (15) after being taken out.

In the filter press (15), the precipitates are pressurized and dewatered, and therefore, the solid cake C15 containing the heavy metals and the filtrate F15 are filtered and separated. The filtrate F15 is fed to the reaction vessel (11), added to the reaction vessel (11) along with the filtrate F2, and circulated and used.

In addition, if necessary, the water W is introduced into the filtering device (15), the moisture that contains the residual soluble components in the precipitates may be cleaned away by the water W. In the cleaning with the water W, the water W is fed to the precipitates by pressure from one direction in a state where the filtering device (15) is pressurized. Therefore, the cleaning is effectively conducted with a small quantity of water.

The obtained dewatered cake solid components C15 are effectively used as the raw material for cement. For example, when the solid components C15 are directly fed to cement manufacturing equipment, the solid components are mixed with other raw material for cement, and after the resulting mixture is dried and ground, it is used so as to be recirculated as a powder raw material for cement in a cement burning step and burnt as cement clinker.

On the other hand, the supernatant F12 that is discharged from the flocculate vessel (12) is fed to the chelating vessel (13), a chelating agent or chelating resin is added to supernatant, the residual heavy metals in the supernatant F12 are captured, and a chelate is formed. Known chelating agents or chelating resins are used.

### (Precise Filtering Step)

Subsequently, the slurry 13 containing the chelate formed at the chelating vessel (13) is introduced to the precise filtering device (14), and the chelate is removed by a membrane filter (MF: precise filter film) or the like.

There is 1 mg/L or less of suspended matter (SS component) contained in the filtrate F14 from the membrane filter 14, which is not environmentally a problem, and therefore, the filtrate F14 can be discharged to a sewage system or the like.

Moreover, the solid components M14 that are obtained by the precise filtering device (14) are circulated to the flocculate vessel (12) and retreated.

Heavy metals are completely removed from the filtrate F14, and the filtrate can be discharged to the sewage system. In addition, if necessary, the filtrate F14 is introduced to an activated carbon adsorption tower (30) before being discharged to the sewage system and the contained minor components may be removed.

In addition, at this time, the filtrate F29 that is discharged in the desalinated dust treatment as below and the filtrate F14 may be collectively subjected to waste water treatment.

### B. Desalinated Dust

### [Water Washing and Filtering Step Y]

### (Dissolving Step)

First, the desalinated dust which is chlorine-containing waste D is input to the dissolving vessel (21), water W of an amount which fluidizes the desalinated dust is added in an amount of 2 to 10 times by mass that of the desalinated dust D and stirred, the desalinated dust becomes a slurry, and soluble components such as the contained chlorine compound are eluted and repulped.

As the water W, industrial water, second drainage that is discharged from manufacturing steps or the like, or waterworks, or the like is used.

Here, the reason why the added amount of the water is as above is because the elution of the soluble components in the chlorine-containing waste D is not sufficiently conducted and the soluble components, that remain in each of desalinated cake solid components (C22) obtained by being filtered through filters (22) of the subsequent state, are increased if the mass of the added amount of the water is 2 times or less than that of the chlorine-containing waste D.

In addition, viscosity of the obtained slurry is increased, and pumping toward the subsequent step is difficult. Moreover, if the mass of the added amount of the water is 10 times or more than that of the chlorine-containing waste D, elution of other components such as heavy metals is increased, and therefore, in the subsequent step, the amount of chemical agents used for removing the components increases.

In the repulping, in order to increase dissolution rates of the soluble components, a temperature in the inner portion of the dissolving vessel (21) may be increased to 40° C. or more. In addition, chlorine component can be sufficiently dissolved within 10 hours of stirring. However, stirring for a long time generates double salt of calcium, alkali components, and chlorine that are contained in the dust, precipitates are generated, and therefore, there is a concern that sufficient desalination may not be conducted, which is unfavorable.

### (Filtering Step)

The slurry S21 generated by the repulping is input to the filtering device (22), is compressed, and is subjected to the solid-liquid separation. Therefore, the solid components C22 of the fly ash dewatered cake and the filtrate F22 are separated.

As the filtering device, a filter press or a belt filter is used.

In addition, if necessary, water W is introduced into the filtering device 22 and moisture containing residual soluble components in the solid components C22 may be cleaned by the water W. In the cleaning of the water W, the water W is fed to the solid components C22 by pressure from one direction in a state where the filtering device (22) is pressurized. Therefore, the cleaning is effectively conducted with small quantity of water.

It is preferable that the water W used for conducting the cleaning be a mass amount of 0.5 to 2.0 times with respect to the amount of the waste that is supplied in the desalination and cleaning.

The solid components C22 of the obtained fly ash dewatered cake are effectively used as the raw material for cement. For example, when the solid components C22 are directly fed to cement manufacturing equipment, the solid components are mixed with other raw materials for cement, and after the resulting mixture is dried and ground, it is used so as to be recirculated as a powder raw material for cement in a cement burning step and burnt as cement clinker

### [Water Treatment Step Z]

### (Selenium Removal Step)

In the filtrate F22 that is discharged from the filtering device (22), chlorine is eluted in the desalinated dust D, and the selenium, heavy metals and the like are also included. Therefore, the selenium that is contained in the filtrate F22 is selectively removed.

The filtrate F22 that is discharged from the filtering device (22) is sent to the reaction vessel (23).

pH (hydrogen ion concentration) of the filtrate F22 is approximately 11 to 13, and in order to make the filtrate F22 to be an acid or neutral filtrate, the pH adjusting agent is added to the filtrate F22 input in the reaction vessel (23), and pH of the filtrate F22 is adjusted to approximately 5 to 6. Here, as the pH adjusting agent, inorganic acids such as carbonic acid, hydrochloric acid, nitric acid, and sulfuric acid are appropriately used.

If pH of the filtrate F22 in the reaction vessel (23) after the adjusting is within this range, reduction reaction of the selenium is generated due to reducing agents such as iron powder or ferrous chloride, and removal of the selenium can be conducted. In addition, the reduction reaction is improved as long as pH is decreased to within the range. However, the effect of reducing the use amount of acid and alkali is decreased. On the other hand, the effect of reducing the use amount of the acid and alkali is increased as long as pH is increased. However, at this case, the reduction action is reduced.

Thereby, it is preferable that the pH range adjusted to be 5 to 6.

In the reaction vessel (23), the pH adjusting agent is added, pH is adjusted to within the range, and reducing agents such as iron powder or ferrous chloride are further added to the filtrate F22 in the reaction vessel (23).

The added amount of the reducing agents such as the iron powder or the ferrous chloride for reduction may be an amount that can reduce the selenium contained in the filtrate F22 and precipitate it, and for example, with respect to the filtrate F22, the added amount is preferably 0.5 mass % or more and 4 mass % or less, and is more preferably 1 mass % or more and 2 mass % or less.

The reducing agents such as the iron powder or the ferrous chloride are added to the liquid F 22, are stirred and mixed, and therefore, the mixture becomes the slurry S23.

In this way, the selenium in the filtrate F22 and the iron powder or the ferrous chloride is reacted with each other, and the selenium is reduced by the iron powder or the ferrous chloride and precipitated. The slurry S23 may be heated, and it is preferable that the temperature at the time of the heating be 45° C. to 60° C.

In the process of the reduction, a portion of the iron powder or the ferrous chloride is ionized by the selenium and eluted in the slurry S23 as ferric ions while the selenium is reduced by the iron powder or the ferrous chloride and precipitated. Thereby, the selenium in the slurry S23 is reduced by the iron powder or the ferrous chloride and precipitated. A specific precipitation mechanism is not known. However, it is considered that the reduced selenium is deposited as metal selenium having fine crystal grains and precipitated and the reduced selenium becomes a hydroxide having low water solubility or the reduced selenium is adsorbed to the iron powder or the like and precipitated.

Subsequently, the slurry S23 is input to the settling vessel (24) and is left as is for a predetermined time. In addition, the slurry S23 is settled and separated, and is separated into solid components that contain the selenium which is the precipitates, the iron powder, and the like and the supernatant F24. The precipitates are subjected to the solid-liquid separation and dewatered using a filtering device (for example, a filter press or the like) (27).

In addition, if necessary, the water W is introduced into the filtering device (27), the moisture that contains the soluble component residual in the precipitates may be cleaned by the water W. In the removal by the water W, the water W is fed to the precipitates by pressure from one direction in a state where the filtering device (27) is pressurized. Therefore, the removal is effectively conducted with a small quantity of water.

The obtained dewatered cake solid components C27 are effectively used as raw material for cement. For example, when the solid components C27 are directly fed to cement manufacturing equipment, the solid components are mixed with other raw material for cement, and after the resulting mixture is dried and ground, it is used so as to be recirculated as a powder raw material for cement in a cement burning step and burnt as cement clinker

A portion of the solid components C27 obtained through the filtering device (27) can be repeatedly used as a portion of the iron powder or the like that is added to the slurry of the reaction vessel (23).

If total amount of the added iron powder or the like is repeatedly used as the solid components, ability of removing the selenium is gradually decreased. However, if the solid components are used as a portion of the added iron powder or the like, the ability of removing the selenium can be maintained.

In addition, the filtrate 27 is circulated in the reaction vessel (25) and used.

### (Heavy Metal Removal Step)

In the supernatant F24 that is discharged from the settling vessel (24), chlorine is eluted in the desalinated dust D, and heavy metals and the like are also included. Therefore, a pH adjusting agent is added to the supernatant F24, a polymer flocculant is also added, precipitates that include heavy metals contained in the supernatant F24 are generated, and the precipitates are filtered and separated.

Specifically, the supernatant F24 of the settling vessel (24) is input to the reaction vessel (25), and for a purpose of reduction, coprecipitation, and concentration of a metal and/or an inorganic material, for example, ferrous sulfate (FeSO₄), ferrous chloride (FeCl₂), and the like are added to the supernatant F24 and reacted, and the slurry S25 is generated.

For example, in the heavy metals, pH of the supernatant F24 is approximately 9 to 10.5 in the reaction vessel (25), precipitates of hydroxides of the heavy metals are generated, and therefore, the heavy metals can be significantly removed.

In addition, as the pH adjusting agent, an alkali agent may be used, and most preferably, NaOH may be used.

Subsequently, in the flocculate vessel (26), the polymer flocculant is added to the slurry S25 from the reaction vessel (25), and therefore, heavy metals in the slurry S25, microparticulated heavy metals, or heavy metal hydroxides are agglomerated and settled.

The precipitates in the flocculate vessel (26) are fed to the filtering device (for example, filter press) (27) after being taken out.

In the filter press (27), the precipitates are pressurized and dewatered, and therefore, the solid cake C27 containing the heavy metals and the filtrate F27 are filtered and separated. The filtrate F27 is added to the reaction vessel (25) along with the supernatant F24 that is fed to the reaction vessel (25), and circulated and used.

In addition, if necessary, the water W is introduced into the filtering device (27), and the moisture that contains the residual soluble components in the precipitates may be cleaned away by the water W. In the cleaning with the water W, the water W is fed to the precipitates by pressure from one direction in a state where the filtering device (27) is pressurized. Therefore, the cleaning is effectively conducted with a small quantity of water.

The obtained dewatered cake solid components C27 are effectively used as the raw material for cement. For example, when the solid components C27 are directly fed to cement manufacturing equipment, the solid components are mixed with other raw material for cement, and after the resulting mixture is dried and ground, it is used so as to be recirculated as a powder raw material for cement in a cement burning step and burnt as cement clinker.

### (Electrolysis Step)

On the other hand, the supernatant F26 that is discharged from the flocculate vessel (26) is fed to the electrolysis vessel (28), a current is flowed into the supernatant F26 via electrodes of the electrolysis vessel (28), the supernatant F26 is electrolyzed, and therefore, the dissolved metals are precipitated as oxides and are changed to minute suspended matter. In order to prompt the reaction, sodium hypochlorite may be added.

### (Thallium Removal Step)

Particularly, when the dissolved metal is thallium (Tl), since the metal easily becomes suspended matter, if necessary, a thallium treatment step is provided.

Specifically, the slurry that contains the suspended matter in the electrolysis vessel (28) is subjected to decantation, the suspended matter is settled and, the thallium is recovered. A thiosulfate such as sodium thiosulfate is added to the decantation, and therefore, surplus sodium hypochlorite that is added to the flocculate vessel (26) is removed, and the thallium can be recovered.

### (Precise Filtering Step)

Subsequently, the slurry S28 containing the suspended matter from the electrolysis vessel (28) is fed to a precise filtering device (29), and the minute suspended matter containing metallic oxide is removed by a membrane filter (MF: precise filter film) or the like. 1 mg/L or less of suspended matter (SS component) is contained in the filtrate F29, which is not environmentally a problem, and therefore, the filtrate F29 can be discharged to a sewage system or the like.

Moreover, the solid components M29 that are obtained by the precise filtering device (29) are circulated to the flocculate vessel (26) and retreated.

In addition, the heavy metals in the filtrate F29 are completely removed. However, if necessary, the filtrate F29 is introduced to an activated carbon adsorption tower (30) before being discharged to the sewage system and the contained minor components may be removed.

In this way, according to the present invention, most of harmful materials such as the heavy metals or the like are not included in the drainage, and therefore, the drainage does not adversely affect the environment even though being discharged.

In addition, according to the treatment method for converting chlorine-containing waste into a raw material for cement of the present invention, the solid components that are generated during treating the desalinated dust or the fly ash can be effectively recycled as a raw material or fuel for cement.

### INDUSTRIAL APPLICABILITY

The present invention can be applied to a treatment in which harmful substances are removed from fly ash or desalinated dust containing harmful substance such as chlorine or heavy metals and the fly ash or desalinated dust is converted into a raw material for cement and reused.

### REFERENCE SIGNS LIST

1, 21: dissolving vessel

2, 22, 15, 27: filter press

11, 23, 25: reaction vessel

12, 26: flocculate vessel

13: chelating vessel

14, 29: MF film

24: settling vessel

28: electrolysis vessel

30: activated carbon adsorption tower

F: filtrate, supernatant

S: slurry

M: solid components

C: solid cake of raw material for cement

1. A treatment method for converting chlorine-containing waste into a raw material for cement comprising:
fluidizing the waste (D) by adding water to chlorine-containing fly-ash waste (D) and conducting solid-liquid separation by filtering (2, 22) slurry (S1) in which the chlorine is dissolved (1), using obtained solid cake C2 as the raw material for cement, precipitating (11) heavy metals by adjusting pH of filtrate F2 to 9 to 10 and adding a reducing agent, adding a polymer flocculant (12) to slurry S11 containing the heavy metal precipitates, settling flock by agglomerating the heavy metals, conducting solid-liquid separation (15) by filtering the flock, using obtained solid cake C15 as the raw material for cement, circulating filtrate F15 in the precipitation (11) treatment of the heavy metals, adding (13) a chelating agent to supernatant F12 after separating the settled flock, conducting solid-liquid separation by filtering (14) slurry S13 in which a chelate of the heavy metals is formed, circulating obtained solid components M14 in the polymer flocculant treatment (12), and discharging filtrate F14;
fluidizing the waste by adding water to the chlorine-containing desalinated dust waste (D), conducting solid-liquid separation by filtering (22) slurry S21 in which the chlorine is dissolved (21), using obtained solid cake C22 as the raw material for cement, precipitating and settling (24) selenium by adjusting pH of filtrate F22 to 5 to 6 and adding (23) iron powder or ferrous chloride, conducting solid-liquid separation (27) by filtering the precipitates, using obtained solid cake C27 as the raw material for cement, precipitating (25) heavy metals by adjusting pH of supernatant F24 after separating the settled selenium to 9 to 10 and adding a reducing agent, adding a polymer flocculant (26) to slurry S25 containing the heavy metal precipitates, settling flock by agglomerating the heavy metals, conducting solid-liquid separation (27) by filtering the flock, using the obtained solid cake C27 as the raw material for cement, circulating filtrate F27 in the precipitating (25) treatment of the heavy metals, precipitating metallic oxide by applying direct current to supernatant F26 after separating the flock and electrolyzing (28), conducting solid-liquid separation by filtering (29) slurry S28 containing the metallic oxide, circulating solid components M29 in the polymer flocculant treatment, and discharging filtrate F29; and
conducting the treatment similar to the chlorine containing desalinated dust treatment to the filtrate F2 along with the supernatant F24 after separating the selenium.

2. The treatment method for converting chlorine-containing waste into a raw material for cement according to claim 1,
wherein the slurry S1 in which the fly ash is dissolved in water and the slurry S21 in which the desalinated dust is dissolved in water are not simultaneously subjected to the solid-liquid separation (22) treatment.

3. The treatment method for converting chlorine-containing waste into a raw material for cement according to claim 1,
wherein the chlorine-containing fly-ash waste is further subjected to dioxin pretreatment before dissolving (1) the chlorine by adding water to the chlorine-containing fly-ash waste (D) and fluidizing the waste.

4. The treatment method for converting chlorine-containing waste into a raw material for cement according to claim 1,
wherein the metallic oxide that is precipitated by electrolyzing (28) is an oxide of thallium, and further comprising a treatment that recovers the thallium by conducting decantation of slurry containing the oxide of thallium.

5. The treatment method for converting chlorine-containing waste into a raw material for cement according to claim 1,
wherein the filtrates F14 and F29 are further subjected to activated carbon adsorption (30) treatment before the discharging.

6. A treatment apparatus for converting chlorine-containing waste into a raw material for cement comprising:
a dissolving vessel (1) in which water is added to chlorine-containing fly-ash waste (D), the waste is fluidized, and the chlorine is dissolved, a filtering device (2) in which a solid cake C2 that is obtained by filtering slurry S1 from the dissolving vessel (1) and conducting solid-liquid separation is used as the raw material for cement, a reaction vessel (11) in which pH of filtrate F2 from the filtering device (2) is adjusted to 9 to 10, a reducing agent is added, and heavy metals are precipitated, a flocculate vessel (12) in which a polymer flocculant is added to slurry S11 containing the heavy metal precipitates from the reaction vessel (11), the heavy metals are agglomerated and flock is settled, a filtering device (15) in which the flock is filtered, a solid cake C15 that is obtained by conducted solid-liquid separation is used as the raw material for cement, and filtrate F15 is circulated in the reaction vessel (11), a chelating vessel (13) in which a chelate of the heavy metals is formed by adding a chelating agent to supernatant F12 from the flocculate vessel (12), and a filtering device (14) in which slurry S13 from the chelating vessel (13) is filtered, solid-liquid separation is conducted, solid components M14 are circulated in the flocculate vessel (12), and filtrate 14 is discharged;
a dissolving vessel (21) in which water is added to chlorine-containing desalinated dust waste (D), the waste is fluidized, and the chlorine is dissolved, a filtering device (22) in which a solid cake C22 that is obtained by filtering slurry S21 from the dissolving vessel (21) and conducting solid-liquid separation is used as the raw material for cement, a reaction vessel (23) in which pH of filtrate F22 from the filtering device (22) is adjusted to 5 to 6, iron powder or ferrous chloride is added (23), and selenium is precipitated, a settling vessel (24) in which selenium is settled from slurry 23 containing the selenium that is precipitated from the reaction vessel (23), a filtering device (27) in which a solid cake C27 that is obtained by filtering the precipitates and conducting the solid-liquid separation is used as the raw material for cement, a reaction vessel (25) in which pH of supernatant F24 from the settling vessel (24) is adjusted to 9 to 10, a reducing agent is added, and heavy metals are precipitated, a flocculate vessel (26) in which a polymer flocculant is added to slurry S25 containing the heavy metal precipitates from the reaction vessel (25), the heavy metals are agglomerated and flock is settled, a filtering device (27) in which a solid cake C27 that is obtained by filtering the flock and conducting the solid-liquid separation is used as the raw material for cement and filtrate F27 is circulated in the reaction vessel (25), an electrolysis vessel (28) in which electrolysis is conducted by applying direct current to supernatant F26 from the flocculate vessel (26) and metallic oxide is precipitated, a filtering device (29) in which slurry S28 containing the metallic oxide from the electrolysis vessel (28) is filtered, solid-liquid separation is conducted, solid components M29 are circulated in the flocculate vessel (26), and filtrate F29 is discharged,
wherein the filtrate F2 is introduced to the filtering device 22 and is subjected to a treatment similar to the chlorine containing desalinated dust treatment.

7. The treatment apparatus for converting chlorine-containing waste into a raw material for cement according to claim 6,
wherein the slurry S1 in which the fly ash is dissolved in water and the slurry S21 in which the desalinated dust is dissolved in water are not simultaneously introduced to the filtering device (22).

8. The treatment apparatus for converting chlorine-containing waste into a raw material for cement according to claim 6, further comprising:
a dioxin treatment device in which the chlorine-containing fly-ash waste is subjected to dioxin pretreatment before being introduced to the dissolving vessel (1).

9. The treatment apparatus for converting chlorine-containing waste into a raw material for cement according to claim 6,
wherein the metallic oxide that is precipitated by the electrolysis vessel (28) is an oxide of thallium, and
further comprising recovering means in which the thallium is recovered by conducting decantation of the slurry containing the oxide of thallium.

10. The treatment apparatus for converting chlorine-containing waste into a raw material for cement according to claim 6, further comprising:
an activated carbon adsorption device (30) that conducts an activated carbon treatment before discharge of the filtrate F14 and filtrate F29.

11. The treatment method for converting chlorine-containing waste into a raw material for cement according to claim 2,
wherein the metallic oxide that is precipitated by electrolyzing (28) is an oxide of thallium, and further comprising a treatment that recovers the thallium by conducting decantation of slurry containing the oxide of thallium.

12. The treatment method for converting chlorine-containing waste into a raw material for cement according to claim 2,
wherein the filtrates F14 and F29 are further subjected to activated carbon adsorption (30) treatment before the discharging.

13. The treatment method for converting chlorine-containing waste into a raw material for cement according to claim 3,
wherein the filtrates F14 and F29 are further subjected to activated carbon adsorption (30) treatment before the discharging.

14. The treatment apparatus for converting chlorine-containing waste into a raw material for cement according to claim 7, further comprising:
a dioxin treatment device in which the chlorine-containing fly-ash waste is subjected to dioxin pretreatment before being introduced to the dissolving vessel (1).

15. The treatment apparatus for converting chlorine-containing waste into a raw material for cement according to claim 7,
wherein the metallic oxide that is precipitated by the electrolysis vessel (28) is an oxide of thallium, and
further comprising recovering means in which the thallium is recovered by conducting decantation of the slurry containing the oxide of thallium.

16. The treatment apparatus for converting chlorine-containing waste into a raw material for cement according to claim 8,
wherein the metallic oxide that is precipitated by the electrolysis vessel (28) is an oxide of thallium, and
further comprising recovering means in which the thallium is recovered by conducting decantation of the slurry containing the oxide of thallium.

17. The treatment apparatus for converting chlorine-containing waste into a raw material for cement according to claim 7, further comprising:
an activated carbon adsorption device (30) that conducts an activated carbon treatment before discharge of the filtrate F14 and filtrate F29.

18. The treatment apparatus for converting chlorine-containing waste into a raw material for cement according to claim 8, further comprising:
an activated carbon adsorption device (30) that conducts an activated carbon treatment before discharge of the filtrate F14 and filtrate F29.

19. The treatment apparatus for converting chlorine-containing waste into a raw material for cement according to claim 9, further comprising:
an activated carbon adsorption device (30) that conducts an activated carbon treatment before discharge of the filtrate F14 and filtrate F29.
